(19) United States
(12) Patent Application Publication
(10) Pub. No.: US 2007/0205530 A1
(43) Pub. Date: Sep. 6, 2007

(54) APPARATUS AND METHODS FOR DISTRIBUTING A BALANCED AIR STREAM TO AN EXTRUSION DIE OF A MELTSPINNING APPARATUS

(75) Inventor: Matthew Duane Thompson, Cumming, GA (US)

Correspondence Address: MOORE & VAN ALLEN PLLC, P.O. BOX 13706, Research Triangle Park, NC, 27709, US

(73) Assignee: NORDSON CORPORATION, Westlake, OH (US)

(21) Appl. No.: 11/276,485

(22) Filed: Mar. 2, 2006

(51) Int. Cl. B28B 5/00

(52) U.S. Cl. 264/211.14; 425/72.2

(57) ABSTRACT

A distribution manifold for transferring a balanced air stream to an extrusion die of a meltspinning apparatus, meltspinning apparatus including the distribution manifold, and methods of operating a meltspinning apparatus. The distribution manifold comprises a body member having a cavity, an inlet coupling the cavity with the air supply, and a plurality of outlet passages coupling the cavity with the extrusion die. A plurality of metering elements are disposed within the cavity between the inlet and the plurality of outlet passages to restrict the flow of air through gaps formed between adjacent pairs of the metering elements.

### FIELD OF THE INVENTION

The present invention relates generally to meltspinning apparatus and methods and, more particularly, to meltspinning apparatus and methods with a balanced airflow distribution to an extrusion die.

### BACKGROUND

Meltspinning techniques, such as spunbonding or meltblowing techniques, for extruding fine diameter filaments of a polymer melt find many different applications in various industries including, for example, nonwoven material manufacturing. Spunbonded and/or meltblown materials are used in many consumer and industrial products, including but not limited to disposable diapers, incontinence diapers, surgical gowns and other disposable protective attire, bedding, pillows, furnishings, geotextiles, carpet underlayment, medical products, and fluid filters.

Meltspinning apparatus generally extrude filaments of a thermoplastic material from an extrusion die having a relatively large width and impinge the extruded filaments with an air stream. A spunbond extrusion die includes a spinneret usually consisting of a flat perforated plate arranged across the width of a production line. A polymer melt is forced through numerous small orifices or holes in the spinneret to form a descending curtain of continuous filaments.

A meltblowing apparatus includes an extrusion die with a die tip or nosepiece, also referred to as a spinneret, having numerous small orifices or holes arranged in a straight line along the crest of nosepiece. A polymer melt is extruded from these holes to form filament strands that are subsequently attenuated by high-velocity heated air to form fine fibers. Air manifolds supply the high velocity heated air, also called primary air, through slots defined in the die nosepiece for impinging the filament strands to cause attenuation and form the fine fibers. Smaller orifices are usually employed in meltblowing techniques compared to those generally used in spunbonding techniques.

One problem associated with conventional meltspinning apparatus involves the cost and complexity of the manifolds used to effectively transfer air to the spinneret or extrusion die. For example, a large manifold is often required to ensure that balanced distribution of the flow of air to the extrusion die or spinneret. A balanced airflow helps to insure uniformity among the filaments discharged across the width of the extrusion die or spinneret. Another problem encountered in conventional meltspinning apparatus is the inability to provide a balanced air distribution across the width of the extrusion die or spinneret. Any deviations from balanced air distribution may result in non-optimized characteristics and properties of the nonwoven web formed from the collected filaments impinged by different portions of the airflow after extrusion from the spinneret or extrusion die.

For these and other reasons, it would be desirable to provide a meltspinning apparatus with an air distribution manifold that is easily manufactured while providing a balanced distribution of airflow to an extrusion die or spinneret.

### SUMMARY OF THE INVENTION

The present invention provides a distribution manifold for transferring an air stream from an air supply to an extrusion die in a meltspinning apparatus. The distribution manifold includes a body member having a cavity, an inlet coupling the cavity with the air supply, and a plurality of outlet passages coupling the cavity with the extrusion die. The air stream flows in the cavity from the inlet to the outlet passages. The distribution manifold further includes a plurality of metering elements disposed within the cavity between the inlet and the outlet passages. Each adjacent pair of metering elements is separated by a corresponding one of a plurality of gaps. The air stream flows through the gaps before entering the plurality of outlet passages. Because the air stream is constrained to flow through the gaps, the metering elements restrict the airflow to create backpressure. This backpressure helps balance the mass flow of the air through the various gaps before the airflow enters the outlet passages.

In another aspect, a meltspinning apparatus is provided for converting a heated liquid into a plurality of filaments and directing an air stream at the plurality of filaments. The meltspinning apparatus comprises a liquid manifold including a liquid passage for the heated liquid. The meltspinning apparatus further comprises an air distribution manifold including a cavity having an inlet communicating with the air stream, a plurality of metering elements disposed within the cavity, and a plurality of outlet passages. Each adjacent pair of metering elements is separated by a corresponding one of a plurality of gaps through which the air stream flows through the cavity to the outlet passages. An extrusion die is coupled with the liquid and air distribution manifolds. The extrusion die communicates with the liquid passage for discharging the heated liquid received from the liquid manifold as a plurality of filaments. The extrusion die communicates with the outlet passages for discharging the air stream received from the air distribution manifold at the filaments.

In another aspect of the present invention, a method for distributing a flow of an air stream in a meltspinning apparatus comprises flowing the air stream through a cavity from an inlet to a plurality of outlet passages and balancing a mass flow of the air stream into the plurality of outlet passages with a plurality of flow constrictions positioned in the cavity between the inlet and the plurality of outlet passages. The method further comprises communicating the air stream from the plurality of outlet passages to an extrusion die.

Advantageously, the air distribution manifold of the present invention may be easily manufactured while still achieving the goal of providing a balanced distribution of airflow directed to attenuate the extruded fibers. The ease of manufacture, which is due at least in part to the simplicity of the device design, reduces the cost to machine the distribution manifold of the present invention. The present invention eliminates the need for a large conventional external air manifold to provide a balanced air distribution to a meltblown extrusion die or to a spin pack. The air distribution manifold of the present invention may be used for both spunbond and meltblown applications.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1 is an exploded perspective view of a manifold assembly for directing a heated liquid or air to an extrusion die;

FIG. 2 is a cross sectional view taken generally along line 2-2 in FIG. 1;

FIG. 3 is perspective view of a distribution manifold of the manifold assembly shown in FIG. 1; and

FIG. 4 is an enlarged perspective view of a portion of the distribution manifold shown in FIG. 3.

### DETAILED DESCRIPTION

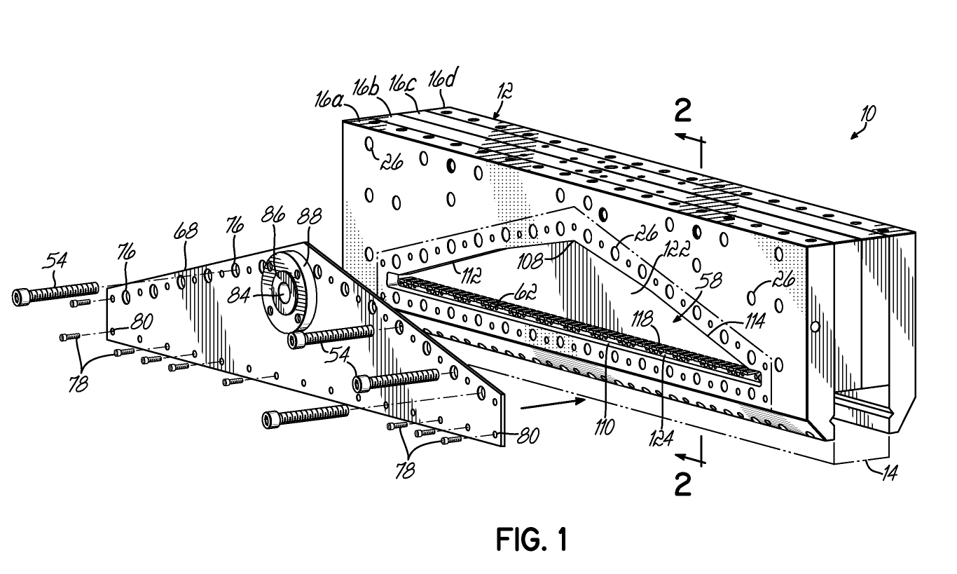

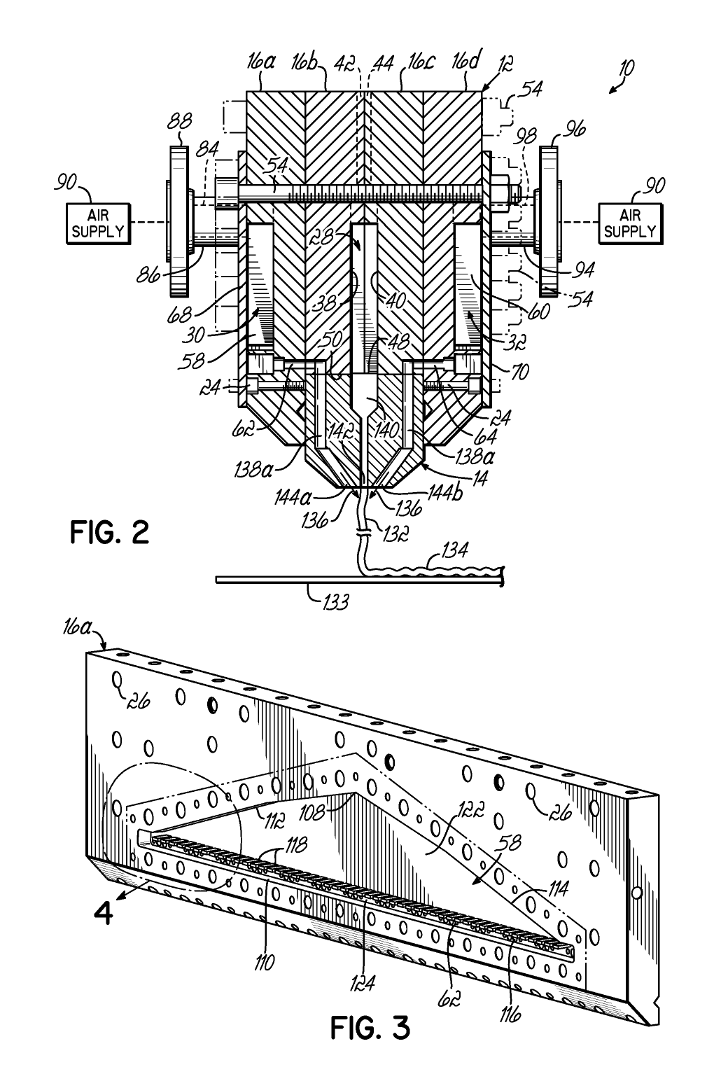

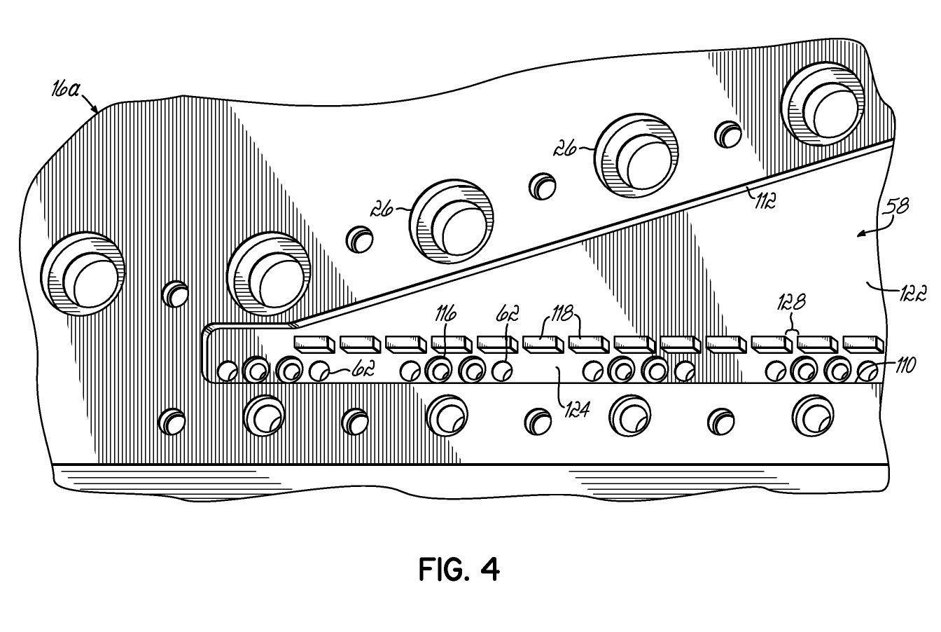

With reference to FIGS. 1-4, a meltspinning apparatus 10 is equipped to convert a heated liquid, such as a molten or semi-solid, melt-processable thermoplastic polymer, into a curtain of filaments 132 and direct one or more air streams 136 at the filaments 132 discharged or otherwise extruded from the meltspinning apparatus 10. A collector 133 collects the filaments 132 to form a nonwoven web 134 and mechanically supports the nonwoven web 134 as web 134 is transported in a machine direction away from the meltspinning apparatus 10 for further processing. Generally, the nonwoven web 134 is a flexible continuous sheet layer having a structure of individual filaments 132 interlaid in a random manner to have an open, porous structure. For simplicity, details of the construction of the nonwoven web 134 are omitted from FIG. 2. In certain embodiments of the invention, the nonwoven web 134 may constitute an individual layer in a laminate consisting of two or more individual layers.

Meltspinning apparatus 10 includes a manifold assembly 12 and an extrusion die or spinneret 14 coupled in fluid communication with the manifold assembly 12. The manifold assembly 12 includes a plurality of body or plate members 16a, 16b, 16c, 16d, such as a lamellar or plate-like construction that advantageously aids in the efficient transfer of air and liquid to extrusion die 14. Fasteners 54 extend through registered holes 26 in plate members 16a-d to secure the plate members 16a-d in an abutting side-by-side relation. The manifold assembly 12 may be heated to, for example, maintain a process temperature for heated liquid flowing through the manifold assembly or to heat the process air, or other gas, supplied to the manifold assembly 12. Accordingly, heating elements (not shown) may be positioned between or in the individual plate members 16a-d to heat the liquid and/or air flowing through manifold assembly 12.

Inner plate members 16b, 16c, which are coextensive, cooperate to define a liquid distribution manifold. Specifically, inner plate members 16b, 16c bound a feed channel or liquid passage 28 that transfers heated liquid pumped from an extruder (not shown) to the extrusion die 14. As best shown in FIG. 2, the liquid passage 28 is defined by respective recesses 38, 40 and inlet slots 42, 44 that align with each other in abutting surfaces of inner plates 16b, 16c. Recesses 38, 40 generally terminate in an elongate liquid outlet slot 48 at a top surface 50 of extrusion die 14. The liquid outlet slot 48 communicates with liquid passageways 140 inside the extrusion die 14 that direct the heated liquid for extrusion from die 14 as filaments 132. Although only a single liquid passage 28 is shown in the figures, a person having ordinary skill in the art will appreciate that the manifold assembly 12 may include additional plate members each having a liquid passage for applications that produce multicomponent filaments. Exemplary plate arrangements are shown and described in commonly-assigned U.S. Patent Application 2005/0046090, the disclosure of which is incorporated by reference herein in its entirety.

Outer plate members 16a, 16d operate as air distribution manifolds containing respective air passages 30, 32 for transferring an air stream to the extrusion die 14. Air passage 30 includes a cavity 58 defined in the constituent material of the outer plate member 16a and a plurality of outlet passages 62 that extend through the thickness of the outer plate member 16a. Cavity 58, which generally has a coathanger shape, is closed off by securing a cover member 68 to the outer plate members 16a. Similarly, air passage 32 includes a cavity 60 defined in outer plate member 16d and a plurality of outlet passages 64 that extend through the thickness of the outer plate member 16d.

With continued reference to FIGS. 1-4, cavity 60, which also generally has a coathanger shape, is closed off by securing cover member 70 to outer plate member 16d. In an alternative embodiment, either cavity 58 or cavity 60 may be closed off by securing an additional plate member (not shown) similar to plate members 16a-d rather than cover member 68, 70, respectively. Additionally, those skilled in the art will further appreciate that cavity 58, for example, may be formed as a compartment inside plate member 16a so as to eliminate the need for a cover member or the like.

Extrusion die 14 may be any suitable extrusion die having liquid passages 140 coupled with the liquid outlet slot in inner plate members 16b,c. Outlet orifices 142 of the liquid passages 140 extend along the underside of the extrusion die 14. A descending curtain of filaments 132 is extruded from the outlet orifices 142. Extrusion die 14 also includes air slots 138a,b each communicating at a respective open end with the outlet passages 62, 64 for receiving the balanced air streams from cavities 58 and 60 and discharging the air streams 136 from slotted discharge outlets 144a,b, respectively, toward the filaments 132. The air streams 136 discharged from the slotted discharge outlets 144a,b impinge the filaments 132 discharged from the outlet orifices 142 for attenuating, or otherwise affecting, the filaments 132 to form fine fibers that are subsequently collected as nonwoven web 134 on collector 133. The air streams 136 are illustrated in FIG. 2 as impinging two diametrically opposed sides of the curtain of filaments 132 extruded from extrusion die 14, although the invention is not so limited.

Holes 76 penetrate through the cover member 68 and receive fasteners 24 that are used to secure cover member 68 with bolt holes 116 plate member 16a. Smaller fasteners 78 extend through additional holes 80 spaced along the perimeter of cover member 68 to attach cover member 68 to plate member 16a. An inlet 84 extending through cover member 68 provides an access path for process air into the cavity 58. Inlet 84 extends through a short, flanged spool 86 coupled at one open end with a registered opening in cover member 58. A mating flange 88 on spool 86 is configured for attaching a supply line extending to an air supply 90 (FIG. 2). Cover member 70 includes a similar spool 94 and mating flange 96 such that the air supply 90 is coupled with an inlet 98 extending through cover member 70.

With continued reference to FIGS. 1-4, cavity 58 is inset into a side surface of the plate member 16a and generally has a triangular cross-sectional shape bounded by a base 110 and inclined side surfaces 112, 114. The side surfaces 112, 114 converge toward an apex 108 located proximate to inlet 84. Accordingly, cavity 58 has a “coat hanger” configuration. Outlet passages 62 are substantially linearly aligned adjacent to base 110. Adjacent pairs of outlet passages 62 have a substantially uniform spacing therebetween, which advantageously facilitates the transfer of air to extrusion die 14, as will be described in greater detail below.

A plurality of flow restrictions represented by metering elements 118 are disposed within the cavity 58 at a location between apex 108 and base 110. The metering elements 118 may be disposed with a side-by-side or linear arrangement so as to define aligned row located proximate to base 110 and outlet passages 62, although the invention is not so limited. The metering elements 118 sub-divide or partition the cavity 58 into first and second compartments or sections 122, 124 that are contiguous and communicate with each other through gaps 128 between the metering elements 118. The outlet passages 62 communicate at one open end with the second section 124 of cavity 58. Cavity 60, which has a construction substantially identical to cavity 58, also includes a set of metering elements (not shown) that are equivalent in structure and function to metering elements 118.

Metering elements 118 may be secured to the plate member 16a within cavity 58 or, alternatively, may be integrally formed with the constituent material of the plate member 16a. The metering elements 118 may be uniform in shape and size, each having a rectangular prism-like configuration or parallelepiped shape, although the invention is not so limited. For example, in one embodiment of the present invention, the metering elements 118 may have a cross-sectional width of 0.625″ and a height of 0.225″. The depth or length of metering elements 118 may be any desired distance, but advantageously corresponds to the depth of cavity 58. Thus, if cavity 58 is 1″ deep, then metering elements 118 are advantageously 1″ long. Such a relationship enables metering elements 118 to extend across cavity 58 and abut cover member 68 when cavity 58 is closed off. Adjacent pairs of metering elements 118 are spaced apart from each other so as to define a corresponding one of a plurality of slots or gaps 128 therebetween. Because metering elements 118 are equally spaced apart and uniform in size, gaps 128 have a substantially equal center-to-center spacing. For example, each gap 128 may have a spacing of 0.25″. Metering elements 118 and gaps 128 define flow constrictions between first and second sections 122, 124 of cavity 58.

In various embodiments of the present invention, the metering elements 118 may other shapes and sizes. For example, the metering elements may have circular or polygonal cross-sections viewed in a direction normal to the side surface of plate member 16a. The metering elements may also be dome-shaped or pyramid-shaped. One or more of these various shapes may be utilized in any particular application, along with one or more variations in size. Additionally, the metering elements 118 may be arranged in a nonlinear pattern with non-uniform spacing or in some other manner between the first and second sections 122, 124 of cavity 58. Thus, the number, shape, size, and arrangement of the metering elements 118 may be tailored to provide constrictions supplying a desired application-specific balanced airflow through the cavity 58.

In use and with reference to FIGS. 1-4, heated liquid is supplied to the inlet slots 42, 44 in manifold assembly 12. The liquid flows through recesses 38, 40 before reaching elongate liquid outlet slot 48. Extrusion die 14 then receives the liquid from elongate outlet slot 48 and discharges the liquid from outlet orifices 142 to produce extruded filaments 132 of thermoplastic material. A continuous stream of air is directed from air supply 90 through inlets 84, 98 into cavities. The air stream flows in each of the individual cavities 58, 60 from the corresponding inlet 84, 98, respectively, toward the outlet passages 62, 64. In each of the cavities 58, 60, the associated air stream intersects the metering elements 118 with a main velocity component approximately perpendicular to the side surface of each of the metering elements 118. The air stream flowing in, for example, cavity 58 in outer plate member 16a travels from first section 122 through the gaps 128 between metering elements 118 into second section 124, where the air stream recombines for flow into outlet passages 62. The flow of the air stream in cavity 60 in outer plate member 16d is similar.

The metering elements 118 balance the distribution of the air stream by constraining the air stream to flow through gaps 128. More specifically, metering elements 118 restrict the airflow through cavities 58, 60 so as to create backpressure that evenly distributes, or meters, a mass flow of air through each gap 128. For example, cavities 58, 60 and metering elements 118 may be designed such that the mass flow of air through each gap 128 is within about ±5% of the average mass flow through all of the gaps 128. The mass flow through gaps 128 may be simulated, calculated, or experimentally measured for the purposes of determining the balancing effect. The balancing effect supplied by the metering elements 118 improves upon the distribution afforded by the coat-hanger geometry of cavities 58, 60.

The balanced air stream originating from each of the cavities 58, 60 is communicated with the corresponding one of the air slots 138a,b and is ultimately discharged from slotted discharge outlets 144a,b to impinge the filaments 132. The attenuated filaments 132 are then collected on the moving collector 133 as nonwoven web 134. Supplying a balanced distribution of air to the outlet passages 62 from each of the cavities 58, 60 ultimately improves the uniformity of filament attenuation across the length of the extrusion die 14. The effect of the uniformity is manifested by optimization of the characteristics and properties of the nonwoven web 134 formed from the collected filaments 132.

Persons having ordinary skill in the art will further appreciate that the metering elements 118 may have other applications relating to balancing the mass flow of any compressible or incompressible fluid through a cavity. In particular, the spaced confined by the recesses 38, 40 in inner plate members 16b, 16c may be provided with a set of metering elements similar to metering elements 118 to assist in balancing the mass flow of the heated liquid to extrusion die 14.

While the invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicant's general inventive concept.

What is claimed is:

1. A distribution manifold for transferring an air stream from an air supply to an extrusion die in a meltspinning apparatus, comprising:
a body member having a cavity, an inlet coupling said cavity with the air supply, and a plurality of outlet passages coupling said cavity with the extrusion die, the air stream flowing in said cavity from said inlet to said plurality of outlet passages; and
a plurality of metering elements disposed within said cavity between said inlet and said plurality of outlet passages, each adjacent pair of said plurality of metering elements being separated by a corresponding one of a plurality of gaps, and the air stream flowing through said plurality of gaps before entering said plurality of outlet passages.

2. The distribution manifold of claim 1 wherein said plurality of metering elements cooperate to balance the air stream such that a mass flow of a portion of the air stream through each of said plurality of gaps is within about ±5% of an average mass flow through said plurality of gaps.

3. The distribution manifold of claim 1 wherein said plurality of metering elements have a side-by-side arrangement to define an aligned row, and said plurality of gaps between have a substantially equal spacing.

4. The distribution manifold of claim 1 wherein said body member further comprises:
a plate member including said cavity; and
a cover member mounted to said plate member for closing said cavity, said plurality of metering elements extending across said cavity between said plate member and said cover member.

5. The distribution manifold of claim 1 wherein said cavity includes a first compartment having a substantially triangular cross-sectional shape with an open base and inclined side surfaces converging toward an apex, said inlet being located proximate to said apex, and said plurality of metering elements being located proximate to said base.

6. The distribution manifold of claim 5 wherein said cavity includes a second compartment separated from said first compartment by said plurality of metering elements, each of said plurality of outlet passages communicating with said second compartment, and the air stream flowing from said first compartment through said plurality of gaps into said second compartment and recombining for flow into said plurality of outlet passages.

7. The distribution manifold of claim 6 wherein said plurality of metering elements are linearly arranged between said first and second compartments.

8. The distribution manifold of claim 6 wherein said plurality of outlet passages are linearly arranged with a substantially uniform spacing between adjacent pairs of said plurality of outlet passages.

9. The distribution manifold of claim 1 wherein said plurality of outlet passages are linearly arranged with a substantially uniform spacing between adjacent pairs of said plurality of outlet passages.

10. A meltspinning apparatus for converting a heated liquid into a plurality of filaments and directing an air stream at the plurality of filaments, comprising:
a liquid manifold including a liquid passage for the heated liquid;
an air distribution manifold including a cavity, a plurality of metering elements disposed within said cavity, and a plurality of outlet passages, said cavity having an inlet communicating with said air stream, each adjacent pair of said metering elements being separated by a corresponding one of a plurality of gaps through which the air stream flows through said cavity to said plurality of outlet passages; and
an extrusion die coupled with said liquid manifold and with said air distribution manifold, said extrusion die communicating with said liquid passage for discharging the heated liquid received from said liquid manifold as a plurality of filaments, and said extrusion die communicating with said plurality of outlet passages for discharging the air stream received from said air distribution manifold at the filaments.

11. The meltspinning apparatus of claim 10 wherein said plurality of metering elements cooperate to balance the air stream such that a mass flow of a portion of the air stream through each of said plurality of gaps is within about ±5% of an average mass flow through said plurality of gaps.

12. The meltspinning apparatus of claim 10, wherein said plurality of metering elements have a side-by-side arrangement to define an aligned row, and said plurality of gaps have a substantially equal spacing.

13. The meltspinning apparatus of claim 10 wherein said plurality of metering elements are formed integrally with said body member.

14. The meltspinning apparatus of claim 10 wherein said at least one plate member with said cavity includes a cover member mounted thereto to close said cavity, said plurality of metering elements extending across said cavity between said plate member and said cover member to define said plurality of gaps therebetween.

15. The meltspinning apparatus of claim 10 wherein said cavity includes a first compartment having a substantially triangular cross-sectional shape with an open base and inclined side surfaces converging toward an apex, said inlet being located proximate to said apex, and said plurality of metering elements being located proximate to said base.

16. The meltspinning apparatus of claim 15 wherein said cavity includes a second compartment separated from said first compartment by said plurality of metering elements, each of said plurality of outlet passages communicating with said second compartment, and the air stream flowing from said first compartment through said plurality of gaps into said second compartment and recombining for flow into said plurality of outlet passages.

17. The meltspinning apparatus of claim 16 wherein said plurality of outlet passages are linearly arranged with a substantially uniform spacing between adjacent pairs of said plurality of outlet passages.

18. The meltspinning apparatus of claim 16 wherein said plurality of metering elements are linearly arranged between said first and second compartments.

19. A method for operating a meltspinning apparatus, the method comprising:
flowing an air stream through a cavity from an inlet to a plurality of outlet passages;
balancing a mass flow of the air stream into the plurality of outlet passages with a plurality of flow constrictions positioned in the cavity between the inlet and the plurality of outlet passages; and
communicating the air stream from the plurality of outlet passages to an extrusion die.

20. The method of claim 19 further comprising:
heating the air stream before the air stream exits the plurality of outlet passages.

21. The method of claim 19 further comprising:
extruding a plurality of filaments from the extrusion die; and
directing the air stream from the extrusion die toward the plurality of filaments.
